(19) United States
(12) Patent Application Publication
(10) Pub. No.: US 2015/0275750 A1
(43) Pub. Date: Oct. 1, 2015

(54) Mixed Fuel Electric Power System

(71) Applicant: Caterpillar Inc., Peoria, IL (US)

(72) Inventor: Marcelo C. Algrain, Dunlap, IL (US)

(73) Assignee: Caterpillar Inc., Peoria, IL (US)

(21) Appl. No.: 14/227,248

(22) Filed: Mar. 27, 2014

(51) Int. Cl. F02B 63/04; H02J 7/00; F02B 73/00

(52) U.S. Cl. CPC F02B 63/04; F02B 73/00; H02J 7/0068

(57) ABSTRACT

A power system generator set utilizing at least one engine capable of operating on one fuel source and another engine capable of operating on a different fuel source is provided. Specifically, a power system is provided for providing power to an external load having a base power load and a variable power load wherein the majority of the energy consumed by the external load is provided by an engine having a first fuel source and the majority of the variable power consumed by the external load is provided by an engine having a second fuel source.

### TECHNICAL FIELD

The present disclosure relates generally to the field of electric power systems, and relates more particularly to an electric generator sets for electric power systems utilizing at least one engine capable of operating on one fuel source and another engine capable of operating on a different fuel source.

### BACKGROUND

An electric power system generally is comprised of a generator set for generating electric power and other equipment for controlling, switching and transmitting the generated power to a load created by an application. A generator set typically comprises at least one, and usually more, generators having a prime mover, such as a combustion engine, associated therewith. In a typical generator set, prime movers capable of operating on only a single fuel source, such as gas or diesel, are used. In such sets, a mixture of the fuel and air is burned within the combustion engine to produce a mechanical rotation that drives the generator to produce electric power. Ideally, the engine drives the generator and produces electric power having relatively constant characteristics (frequency, voltage, etc.).

Power systems incorporating generator sets of the type described herein are often used as a source of power, for example, to supply electric machinery, such as an electric shovel or dragline, with power. Likewise power systems of this type may supply a hospital, a manufacturing facility, a military facility, or the like with power. Although effective, power systems of this type, by themselves, are not generally efficient in responding immediately to sudden changes in power demand. For example, when an electric shovel starts to operate a motor that is carrying a heavy load, the power demand can quickly increase. Without intervention, a change in power demand of this type can result in an abrupt and undesirable frequency change in the output power. In the past, issues of this type have been handled by utilizing a prime mover and generator combination that is large enough to account for the highest forecasted demand scenario with little change in frequency and voltage of the supplied power. However, handling these issues in this manner generally results in a generator set that is significantly oversized for the baseline conditions required by the application, thus resulting in capital costs and operating costs that can be significantly higher than optimum.

Another option for dealing with such situations that has been used effectively is through the use of a transient power management system, alson known as a “peak shaver” device. A peak shaver is an efficient power storage system that can effectively store excess energy produced by the generator set during “low load” periods, energy that can then be drawn by the application load from the peak shaver device, as required, during “high load” periods. One specific example of such a peak shaving system includes the system described in U.S. Pat. No. 7,839,027 ('027 patent). The '027 patent discloses systems, apparatuses, and methods for maintaining the state of charge of energy storage devices such as inverters, batteries, flywheels, capacitors, or other technologies that are energetically coupled with the electricity grid to support ancillary services.

Accordingly, while it can be seen that peak shavers can be useful in resolving some efficiency issues experienced in prior art power systems, peak shaving systems alone cannot necessarily resolve all efficiency issues related to prior art power generation systems. This is because there are other factors that significantly affect the overall efficiency and costs associated with power systems operating based upon engine-based generator sets. For example, generator sets operate more efficiently when supplying a steady load, and another factor that greatly affects the overall operating cost of generator sets (whether or not they utilize a peak shaver or not) is the cost of the fuel used to supply the prime mover engines. This can be affected by the fact that some fuels are more expensive in some applications and less expensive (and thus potentially more efficient) in others (i.e. diesel fuel may be particularly expensive in remote mining operations where gas may be relatively cheap in comparison thereto). Further adding to the efficiency issues faced is the fact that diesel-only powered engines and gas-only powered engines do not operate in exactly the same manner, and thus their efficiency profiles, as well as the energy profiles created thereby, can vary significantly. In fact, it has been found that diesel engines tend to have better dynamic response characteristics than gas engines.

Prior art attempts to maintain flexibility in this area have provided prime movers that are capable of utilizing both gas and diesel as a fuel source. For example, Pub. No. US 2012/0292992 A1 to Kevin R. Williams entitled Dual Fuel System and Method of Supplying Power to Loads of a Drilling Rig discloses prime movers for generator sets that can be operated on either gas and/or diesel as their fuel sources (otherwise known as dual fuel engines). However, while dual fuel engines of this type may offer reduced fuel costs and emissions benefits, as well as benefits in being able to pick and choose a desired fuel source based upon cost of the available fuel, these benefits can be limited in circumstances where the generator must switch from higher volume ratios of gas back to higher volume ratios of diesel fuel to meet the loading required by the operating equipment. Examples of applications wherein such a dual fuel system may not be as efficient as desired may include, but is not limited to, draglines used in mining operations.

Accordingly, there is needed a power system utilizing a generator set including both gas powered and diesel powered engines to efficiently power electric generators for use with electric powered equipment, particularly equipment that may be located in remote areas, such as draglines and the like.

### SUMMARY

The present disclosure is directed to a power system and process that can effectively utilize both diesel and gas powered engines to efficiently power electric generators for use with electric powered equipment, particularly equipment that may be located in remote areas and may experience highly dynamic changes in load, such as draglines and the like.

In one illustrative embodiment of the present disclosure, a power system is provided including an electrical generation source having multiple generator sets wherein at least one of the generator sets utilizes a diesel-only engine and at least one of the generator sets utilizes a gas-only engine. Further in accordance therewith, a transient power management system, such as a peak shaver system, may be utilized and a load tracking control system may be provided and used to regulate the operation of the multiple generator sets. In accordance with such an embodiment, the load tracking control may utilize the gas engines to provide the majority of the base load power required by the application, may utilize the diesel engines to provide the majority of the variable load power required by the application, and may supplement both utilizing the peak shaver to provide a highly dynamic source for power required.

In accordance with another illustrative embodiment of the disclosure, the application for which a power system in accordance herewith is used may be evaluated to determine a standard base load condition for power generation required by the application, what comprises normal variable load conditions thereof, and what highly dynamic power may be required from time to time. Then, based upon the evaluation, a generator set may be specified for use with the power system having gas engines sized to provide the majority of the base load power required, having diesel engines sized to provide the majority of the variable load power required, and having a peak shaver device, such as an inverter, sized to provide any remaining dynamic power as may be required by the application. In accordance herewith, a power system may thus be provided and operated wherein the majority of the energy for a work cycle is provided by the gas engines (having a lower fuel cost) while a much smaller amount of the work cycle energy is provided by the diesel engines and the peak shaver device having a near energy neutral contribution (discharging and recharging of the peak shaver would occur within a given work cycle.)

### BRIEF DESCRIPTION OF THE DRAWINGS

FIG. 1 depicts a power system according to an aspect of the disclosure; and

FIG. 2 illustrates a plot of electric generation of components of the power system/requirements of an application requiring electric power over time utilizing aspects of the present disclosure.

### DETAILED DESCRIPTION

There has thus been outlined, rather broadly, certain aspects of the disclosure in order that the detailed description thereof herein may be better understood, and in order that the present contribution to the art may be better appreciated. There are, of course, additional aspects of the disclosure that will be described below and which will form the subject matter of the claims appended hereto.

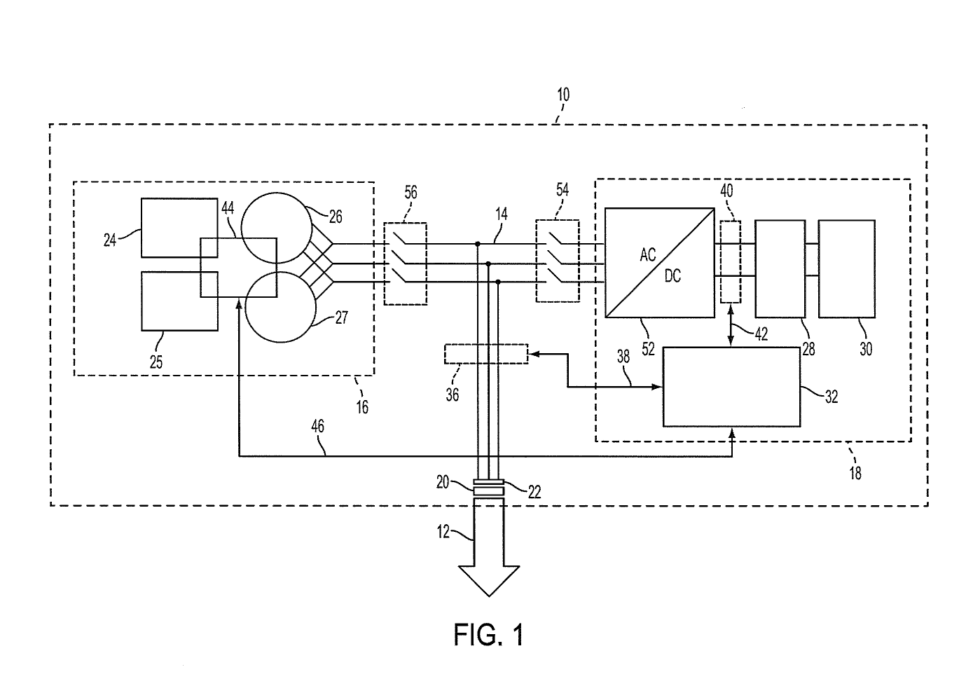

FIG. 1 shows a power system according to an aspect of the disclosure. More specifically, FIG. 1 illustrates a power system 10. The power system 10 may be configured to provide electric power to an external load 12. In one exemplary aspect, the power system 10 may be configured as a primary source of power, if desired. Conversely, in another aspect, it is contemplated that the power system 10 may provide an immediate supply of reserve power provided to the external load 12 when power supplied from a utility power grid is interrupted.

As shown in FIG. 1, the power system 10 may be comprised of at least one generation source 16 and a peak shaver 18. The generation source 16 and the peak shaver 18 may be connected to the external load 12 by way of a power transmission network 20 and a connection 22. The connection 22 may, in part, include lines/connections 14 arranged between the generation source 16, the peak shaver 18, and the connection 22.

The power system 10 may be a self-supporting, electricity generation and/or distribution system such as, for example, a machine (e.g., construction equipment, mining equipment, and/or agricultural equipment such as an electric shovel), motorized vehicle (e.g., a bus or a truck), a power supply for a remote facility, a power supply for a military facility, or the like. One skilled in the art will appreciate that the power system 10 may produce electrical power in multiple phases and/or different frequencies based upon requirements of the external load 12. The power system 10 may produce and/or supply electrical power in the form of alternating electric current such as, for example, three-phase alternating current with a preset frequency (e.g., 50 Hz, 60 Hz, or any other suitable frequency).

The external load 12 may include any type of power consuming system or device configured to receive electrical power and to utilize the electrical power to perform some type of task. The external load 12 may include, for example, electric powered construction or mining equipment, electric machines, lights, motors, heating elements, electronic circuitry, refrigeration devices, air conditioning units, computers, servers, etc. In a particular aspect, the external load 12 may be electric powered construction or mining machines such as an electric shovel.

The power transmission network 20 may embody any electrical transmission system for distributing electrical power generated by the power system 10 to the external load 12. For example, the power transmission network 20 may include a system that includes transmission lines, connection equipment (e.g., transformers, electrical switches, power relays, circuit breakers, and the like), and other suitable devices for distributing electrical power. However, the power transmission network 20 may be implemented with simpler or more complex configurations.

The connection 22 may include any type of electrical connector or system that is capable of coupling the generation source 16, the peak shaver 18, and/or the external load 12. For example, the connection 22 may include various junction boxes, circuit interrupting devices, fuses, or any other components that may be suitable for electrically interconnecting one or more systems. The connection 22 may also or alternatively include a voltage transformer configured to reduce or otherwise condition the voltage or power provided by the generation source 16, and/or the peak shaver 18 to a suitable level for use by conventional consumer devices. Additionally, the connection 22 may be a hardwired connection or a connector.

The generation source 16 may include at least two prime movers each mechanically coupled to a corresponding generator to rotate said generators to provide electric power to the external load 12. In accordance with an embodiment of the disclosure, at least one prime mover may be a gas fuel-only internal combustion engine 24 and at least one prime mover may be a diesel fuel-only internal combustion engine 25. Gas engine 24 may be mechanically coupled to generator 26 and diesel engine 25 may be mechanically coupled to generator 27. As discussed above an herein, each gas engine 24 and diesel engine 25 each may have a desired operating range and, when operating within this range, desired performance that is substantially consistent and efficient thus providing the respective generators 26, 27 that have characteristics (e.g., voltage, frequency, etc.) that are substantially consistent. However, as noted above, the gas engine 24 may be more efficient in generating baseline power relative to the fuel cost, but may generally lack the dynamic characteristics of the diesel engine 25.

The generators 26, 27 may be, for example, AC induction generators, permanent-magnet generators, AC synchronous generators, switched-reluctance generators, or the like that are mechanically driven by the gas engine 24 and diesel engine 25 to produce electric power. In one aspect, the generators 26, 27 may include multiple pairings of poles (not shown), each pairing having three phases arranged on a circumference of a stator (not shown) to produce an alternating current.

The peak shaver 18 may include a plurality of components and subsystems for generating and maintaining a source of power for the power system 10. Specifically, the peak shaver 18 may include a power control 28 and an energy storage device 30. The energy storage device 30 may include any device that can store energy in potential forms, such as one or more capacitors. More specifically the energy storage device 30 may be one or more ultra capacitors, such as electric double-layer capacitors (EDLC), which are also known as super capacitors, super condensers, electrochemical double layer capacitors, or ultra capacitors. The ultra capacitors may be electrochemical capacitors or the like with relatively high energy density. The power supplied to the peak shaver 18 may be used by the power control 28 to charge and/or maintain a charge within the energy storage device 30. Also, the energy storage device 30 may be implemented as a flywheel, an inductor, a battery, a fluid accumulator, and/or the like.

The peak shaver 18 may include a bidirectional AC/DC converter 52. The bidirectional AC/DC converter 52 may receive an alternating current from the generator 26. The alternating current received by the bidirectional AC/DC converter 52 may be converted to direct current. This direct current may be applied to the power control 28 and the energy storage device 30. On the other hand, direct current may be output from the power control 28 and the energy storage device 30 and then may be input to the bidirectional AC/DC converter 52. The bidirectional AC/DC converter 52 may take the direct current and convert the direct-current to an alternating current to be provided to the connection 22 and the power transmission network 20 to provide power to the external load 12.

During normal operation, the peak shaver 18 may receive power from the generation source 16. At any point in time, the peak shaver 18 may selectively absorb excess power by charging the energy storage device 30, or supplement the power directed to the external load 12 by discharging the energy storage device 30 via the power control 28.

In one example, the peak shaver 18 may function to only help maintain consistent electrical output of the generation source 16 under varying loads, when generation source 16 is fully operational. In this disclosure, the peak shaver 18 may smooth operation of the generation source 16 under transient loading to limit abrupt frequency changes. Such an implementation allows for a smaller generation source 16 reducing costs, size, weight, and the like and increasing efficiency.

The power control 28 may embody an electronic device that is configured to convert, condition, control, and/or regulate the production, absorption, and discharge of electrical power within the peak shaver 18 (i.e., the flow of power to and from energy storage device 30). In one aspect, the power control 28 may be configured to regulate the flow of electrical power by receiving an input of direct-current from the bidirectional AC/DC converter 52 (converted from the fixed or variable-frequency, alternating current (AC) from the generation source 16) or providing an augmented output as supplied by the energy storage device 30 to the bidirectional AC/DC converter 52 to provide AC power to the external load 12.

When the generation source 16 is providing power to the external load 12, the power control 28 may cause the energy storage device 30 to selectively absorb or supplement the power provided by the generation source 16 to the external load 12 such that fluctuating load demands of the external load 12 can be satisfied in an efficient and desired manner (i.e., allows time for the engine speed of generation source 16 to deviate from the current operating range). Accordingly, the peak shaver 18 may be provided with a load tracking control 32 to help regulate operation.

The load tracking control 32 may embody single or multiple microprocessors, field programmable gate arrays (FPGAs), digital signal processors (DSPs), etc. that include a means for tracking the load required by the application and controlling an operation of the peak shaver 18 in response thereto. Numerous commercially available microprocessors can be configured to perform the functions of the load tracking control 32. It should be appreciated that the load tracking control 32 could readily embody a microprocessor separate from that controlling other generator set functions, or the load tracking control 32 could be integral with a general generator set microprocessor and be capable of controlling numerous generator set functions and modes of operation. If separate from the general generator set microprocessor, the load tracking control 32 may communicate with the general generator set microprocessor via datalinks or other methods. Various other known circuits may be associated with the load tracking control 32, including power supply circuitry, signal-conditioning circuitry, actuator driver circuitry (i.e., circuitry powering solenoids, motors, or piezo actuators), communication circuitry, other appropriate circuitry and the like.

The load tracking control 32 may be implemented as a hysteresis like controller. According to one aspect, the load tracking control 32 may be configured to monitor performance of the power system 10 and responsively regulate operation of the peak shaver 18. For example, the load tracking control 32 may monitor a voltage, a current, and/or a frequency characteristic of the electrical power provided to the external load 12 with one or more sensors such as sensor 36. The output of the one or more sensors such as sensor 36 may be communicated along a line 38 or wirelessly to the load tracking control 32. The load tracking control 32 may monitor a voltage, a current, and/or a frequency characteristic of the electrical power provided by the peak shaver 18 with one or more sensors such as sensor 40. The output of the one or more sensors such as sensor 40 may be communicated along a line 42 or wirelessly to the load tracking control 32. In response to a deviation of the supplied power from a desired power level (during transient operation), the load tracking control 32 may selectively activate, deactivate, or adjust activation of the peak shaver 18 to supplement or absorb the power being directed to the external load 12. Additionally or alternatively, the load tracking control 32 may monitor operation of the generation source 16 with one or more sensors that may include a sensor 44 providing a signal to the load tracking control 32 along a communication line 46 or wirelessly, and in response to an operational deviation from the desired operating range, the load tracking control 32 may activate, deactivate, or adjust activation of the peak shaver 18 and/or generation source 16. In this manner, the actual demands of the external load 12 may be satisfied while the generation source 16 is adjusted to the desired operating range.

According to another aspect, the load tracking control 32 may predictively regulate operation of the peak shaver 18. Specifically, in response to a measured, calculated, or assumed power demand change of the external load 12, the load tracking control 32 may selectively activate, deactivate, or adjust activation of the peak shaver 18. Similarly, in response to an indication of a desired load change, the load tracking control 32 may regulate operation of the peak shaver 18 to accommodate the change before the change can be measured, calculated, or assumed. In this manner, predicted demand changes of the external load 12 may be satisfied before they are actually experienced by the generation source 16.

The load tracking control 32 may regulate operation of the peak shaver 18 to absorb or supplement power provided to the external load 12 during the transient mode of operation by selectively causing the energy storage device 30 to be charged or discharged. For example, during the transient mode of operation, the load tracking control 32 may cause the energy storage device 30 to absorb or supplement the power provided to the external load 12. For example, during the generation source 16 operation and in response to an actual or predicted sudden increase in load demand, the load tracking control 32 may cause the power control 28 to discharge power from the energy storage device 30 to the external load 12 to account for the increase in demand such that operation of the generation source 16 remains within the desired operating range and the load demand increase is satisfied. Similarly, in response to an actual or predicted sudden decrease in load demand during the generation source 16 operation, the load tracking control 32 may cause the power control 28 to direct excess power from the generation source 16 to charge the energy storage device 30 and account for the decrease such that operation of the generation source 16 is given time to adjust to a new desired operating range.

During a charging event, when excess power produced by the generation source 16 is being absorbed by the peak shaver 18 in response to a sudden decrease in load demand of the generation source 16, the energy storage device 30 may be allowed to charge to a maximum limit. During a discharging event when the peak shaver 18 is supplementing the power directed to the external load 12 to satisfy a sudden increase in load demand, the energy storage device 30 may be allowed to discharge as needed.

In accordance with an aspect of the disclosure, the load tracking control 32 may be used to utilize the gas engine 24 to provide the majority of the base load power required by the external load 12, may utilize the diesel engine 25 to provide the majority of the variable load power required by the external load 12, and may supplement both utilizing the energy storage device 30 to provide a highly dynamic source for power required.

In accordance with another illustrative embodiment of the disclosure, the external load 12 for which a power system 10 in accordance herewith is used by the load tracking control 32 to determine a standard base load condition for power generation required by the external load 12, what comprises normal variable load conditions thereof, and what highly dynamic power may be required from time to time. Next, based upon the evaluation, a generation source 16 is specified for use with the power system 10 having gas engines 24 sized to provide the majority of the base load power required, having diesel engines 25 sized to provide the majority of the variable load power required, and having a peak shaver device 18, such as an inverter, sized to provide any remaining dynamic power as may be required by the external load 12. In accordance therewith, a power system 10 is provided and operated wherein the majority of the energy for a work cycle is provided by the gas engines 24 (having a lower fuel cost) while a much smaller amount of the work cycle energy is provided by the diesel engines 25 and/or the peak shaver device 18.

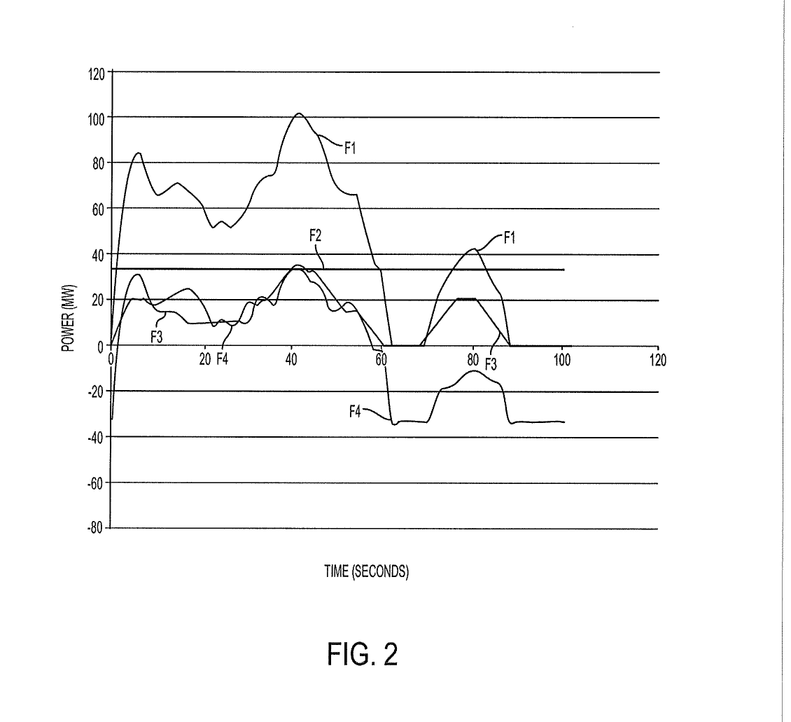

FIG. 2 illustrates a plot of electric generation of the components of the power system 10 and requirements of the external load 12 over time. In particular, the x-axis is time, in seconds, of a typical cycle of an external load 12, such as in a mining dragline and the y-axis is the electric power supplied by the various components of the power system 10 as well as the power required by the external load 12 over that same time period. More specifically, the power supplied/required by the external load 12, such as a mining dragline, is depicted by line F1, the power supplied by the generator 26 connected to the gas engine 24 is depicted by line F2, the power supplied by the generator 27 connected to the diesel engine 25 is depicted by line F3, and the power supplied by the peak shaver 18 is depicted by line F4. In reviewing FIG. 2, it can clearly be seen that a baseline power is provided by the gas engine 24 based generator 26 as the line is essentially flat over the entire length of the cycle. Conversely, the power supplied by the diesel engine 25 based generator 27 and the peak shaver 18 is highly variable over the length of the cycle.

It has been found that utilizing the combination of gas engines 24 and diesel engines 25 in accordance with the foregoing disclosure would result in a cycle wherein roughly ⅔ of the energy would be provided by the gas engines 24 and ⅓ of the energy would be provided by the diesel engines 25. In applying these figures to an external load 12 that has requirements of 167 kW-hr per cycle, such as a typical dragline application, utilizing an all diesel based system would result in fuel costs of approximately $47.49 per cycle (assuming costs of $4 per gallon for diesel fuel and 0.0711 gal/kW-hr for power generated by a diesel engine 25). Conversely, applying the same figures to a mixed fuel power system utilizing gas engine 24 generators 26 in combination with diesel engine 25 generators 26 in accordance with the present disclosure, results in gas fuel costs of $5.29 per cycle and diesel fuel costs of $15.83, for a total cycle cost of $21.12, essentially cutting overall fuel costs in more than one half (assuming diesel fuel costs of $4 per gallon and 0.0711 gal/kW-hr for ⅓ of the total power required generated by a diesel engine 25 and assuming gas fuel costs of $5/1000 scf and 9.5 scf/kW-hr for ⅔ of the total power required generated by a gas engine 24).

### INDUSTRIAL APPLICABILITY

The power system 10 in accordance with the present application may have wide applications. Specifically, because the power system 10 disclosed herein combines the best attributes of diesel engine 25 based power (namely highly dynamic response capabilities) and gas engine 24 based power (low fuel costs), it may be used in many applications, although it is particularly well-suited to applications where diesel fuel may expensive and difficult to obtain (such as remote locations, and, in particular, remote mining locations). Furthermore, the use of the power system disclosed herein may significantly lower capital expenditures, in addition to the operating expenses noted above, as the combination of the use of diesel engine 25 based power with gas engine based power 24, particularly when combined with the use of a peak shaver 18, eliminates the need of oversized generation sources 16.

The many features and advantages of the disclosure are apparent from the detailed specification, and, thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

We claims:

1. A power system comprising:
a first prime mover configured to generate a drive force mechanically coupled to a first generator to produce electric power;
a second prime mover configured to generate a drive force mechanically coupled to a second generator to produce electric power;
an external load having a base power load and a variable power load;
a controller configured to control the operation of said prime movers to discharge power to said external load, wherein said controller controls said first prime mover to provide the majority of the base power load and controls said second prime mover to provide the majority of the variable power load.

2. The power system of claim 1 further comprising a peak shaver device configured to receive electric power from said generators to store electric power or to discharge electric power to said external load as controlled by said controller.

3. The power system of claim 2 wherein said peak shaver device and the second prime mover provide the majority of the variable power load.

4. The power system of claim 1 wherein said first prime mover is a combustion engine characterized by a relatively low dynamic response capability fueled by a first fuel.

5. The power system of claim 4 wherein said first fuel is gas fuel.

6. The power system of claim 4 wherein said second prime mover is a combustion engine characterized by a relatively high dynamic response capability fueled by a second fuel.

7. The power system of claim 6 wherein said second fuel is diesel fuel.

8. The power system of claim 2 further comprising a bidirectional AC/DC converter configured to convert AC power from the generators to DC power for the peak shaver.

9. The power system of claim 2 further comprising a bidirectional AC/DC converter configured to convert DC power from the peak shaver to AC power for the external load.

10. The power system of claim 2 wherein said peak shaver includes at least one of an ultra capacitor, a lithium ion battery, and a high-power lead acid battery.

11. The power system of claim 1 wherein said external load is a dragline.

12. A power system comprising:
a first prime mover configured to generate a drive force mechanically coupled to a first generator to produce electric power, said first prime mover being a prime mover characterized by a relatively low dynamic response capability and a relatively low fuel cost;
a second prime mover configured to generate a drive force mechanically coupled to a second generator to produce electric power, said second prime mover being a prime mover characterized by a relatively high dynamic response capability and a relatively high fuel cost;
an external load having a base power load and a variable power load;
a controller configured to control the operation of said prime movers to discharge power to said external load, wherein said controller controls said first prime mover to provide the majority of the base power load and controls said second prime mover to provide the majority of the variable power load.

13. The power system of claim 12 further comprising a peak shaver device configured to receive electric power from said generators to store electric power or to discharge electric power to said external load as controlled by said controller.

14. The power system of claim 13 wherein said peak shaver device and the second prime mover provide the majority of the variable power load.

15. The power system of claim 12 wherein said first prime mover is a gas combustion engine.

16. The power system of claim 15 wherein said second prime mover is a diesel combustion engine.

17. The power system of claim 13 further comprising a bidirectional AC/DC converter configured to convert AC power from the generators to DC power for the peak shaver.

18. The power system of claim 13 further comprising a bidirectional AC/DC converter configured to convert DC power from the peak shaver to AC power for the external load.

19. The power system of claim 13 wherein said peak shaver includes at least one of an ultra capacitor, a lithium ion battery, and a high-power lead acid battery.

20. A power system comprising:
a first prime mover configured to generate a drive force mechanically coupled to a first generator to produce electric power, said first prime mover being a gas combustion engine;
a second prime mover configured to generate a drive force mechanically coupled to a second generator to produce electric power, said second prime mover being a diesel combustion engine;
a peak shaver device configured to receive electric power from said generators to store electric power or to discharge electric power to said external load;
an external load having a base power load and a variable power load;
a controller configured to control the operation of said prime movers to discharge power to said external load, wherein said controller controls said first prime mover to provide the majority of the base power load and said second prime mover and said peak shaver to provide the majority of the variable power load.
